(19) United States
(12) Patent Application Publication
(10) Pub. No.: US 2005/0201668 A1
(43) Pub. Date: Sep. 15, 2005

(54) Method of connecting an optical element at a slope

(76) Inventor: Avi Neta, Gilon (IL)

Correspondence Address: Lambda Crossing, Ltd.;c/o LandonIP, Inc., Suite 450, 1700 Diagonal Road, Alexandria, VA, 22314-2866, US

(21) Appl. No.: 11/063,594

(22) Filed: Feb. 24, 2005

Related U.S. Application Data
(63) Continuation of application No. 60/551,790, filed on Mar. 11, 2004.
(60) Provisional application No. 60/551,794, filed on Mar. 11, 2004.
(60) Provisional application No. 60/628,139, filed on Nov. 17, 2004.

(51) Int. Cl. G02B 6/12

(52) U.S. Cl. 385/14

(57) ABSTRACT

A planar lightwave circuit comprising: a substrate; an optical waveguide; a trench cut in the substrate opposing a face of the optical waveguide, the trench comprising a sloped wall exhibiting an oblique angle with a center axis of the optical waveguide, the sloped wall opposing the face of the optical waveguide; and an optical element having an active optical area, the optical element being secured on the sloped wall such that the active optical area faces the optical waveguide at the oblique angle. Preferably the oblique angle is between 5°-85°, and even further preferably between 30°-70°.

### CROSS-REFERENCE TO RELATED APPLICATIONS

This application claims priority from U.S. Provisional Patent Application Ser. No. 60/551,790 filed Mar. 11, 2004 entitled “METHOD OF COUPLING FIBER TO WAVEGUIDE”; U.S. Provisional Patent Application Ser. No. 60/551,794 filed Mar. 11, 2004 entitled “METHOD OF CONNECTING AN OPTICAL ELEMENT TO A PLC”; and U.S. Provisional Patent Application Ser. No. 60/628,139 filed Nov. 17, 2004 entitled “METHOD OF CONNECTING AN OPTICAL ELEMENT TO A PLC”, and the entire contents of each of the above mentioned applications are incorporated herein by reference.

### BACKGROUND OF THE INVENTION

The invention relates generally to the field of planar lightwave circuits and in particular to a method of attaching an element in a planar lightwave circuit.

Optical fiber is commonly used in telecommunication equipment to carry an optical signal. Optical sub-components, devices and modules, hereinafter generally referred to as optical components, typically comprise at least one element which operates on the optical signal. Such an operation may comprise conversion between an electrical signal and an optical signal. Advantageously, optical components are produced in the form of a planar lightwave circuit (PLC), thus allowing for consistent mass production and effective cost reduction. Certain elements, such as photodiodes, Fabry Perot laser diodes (FPLD) vertical cavity surface emitting lasers (VCSELs) and vertical external cavity surface emitting lasers (VECSELs) are produced typically independently of the PLC, and must then be installed and connected to the PLC.

A major difficulty in the production of the PLC is the need to attach the independently produced elements to the PLC. Attachment to the PLC requires an electrical connection, a means of physically securing the element to the PLC and a means of ensuring optical alignment between the element and either a fiber secured to, or a waveguide defined on, the PLC.

Typically, independently produced items such as photodiodes are supplied with an active area on the top surface. One connection point, or pad, is typically supplied at the bottom of the photodiode, with a second connection point, or pad, being supplied on the top surface displaced from the active area. In prior art installations the photodiode is connected to a connection point on the substrate, and the top surface connection is made using a ball bonder and a flying connection.

The optical path on a PLC is thus typically parallel with the bottom surface of the photodiode, leading to a challenge in the layout of an optical device. Various solutions to this difficulty are described in the prior art, for example in U.S. Pat. No. 4,897,711 to Blonder et al and U.S. Pat. No. 6,530,698 to Kuhara et al, the contents of both of which are incorporated herein by reference. The use of mirrors and other light bending apparatus adds cost and complexity.

Another aspect that should be taken into account is the physical force of the bonder used. Connection to the pad through the use of a bonder, such as a ball or wedge bonder, requires some physical force, and thus proper support for the photodiode is required in order to avoid damage to the photodiode.

Thus, there is a need for an improved means of attaching an element such as a photodiode to a PLC.

### SUMMARY OF THE INVENTION

Accordingly, it is a principal object of the present invention to overcome the disadvantages of prior art methods of attaching an element to a PLC. This is provided in the present invention by forming a trench in the PLC, the trench exhibiting at least one sloped wall, and placing the element in the trench with its active optical input obliquely facing a fiber or waveguide facet. Preferably the active optical input exhibits an angle of between 5-85° to the plane of the optical waveguide. Further preferably, the angle is between 30-70°. A bonder, such as a ball or wedge bonder, is used to connect to the metal pad on the top surface, and the element is supported against the sloped wall of the trench.

The invention provides for: a planar lightwave circuit comprising: a substrate; an optical waveguide; a trench cut in the substrate opposing a face of the optical waveguide, the trench comprising a sloped wall exhibiting an oblique angle with a center axis of the optical waveguide, the sloped wall opposing the face of the optical waveguide; and an optical element having an active optical area exhibiting a plane, the optical element being secured on the sloped wall such that the plane of the active optical area faces the optical waveguide at the oblique angle.

In one embodiment the optical element comprises at least one metal pad facing the optical waveguide, the optical element being supported by the substrate on a face of the optical element directly opposing the metal pad. In another embodiment the optical element comprises at least one metal pad facing the sloped wall, the metal pad being connected by silver paste.

In one embodiment the optical element comprises one of a photodiode, Fabry Perot laser diode, vertical cavity surface emitting laser and a vertical external cavity surface emitting laser. In another embodiment the optical waveguide is an optical fiber end. In yet another embodiment the trench further comprises a wall generally opposing the sloped wall, a corner of the optical element being in contact with the wall generally opposing the sloped wall, whereby the optical element is aligned at least partially by the being in contact.

In an exemplary embodiment the oblique angle is in the range of 5°-85°, preferably 30°-70°.

The invention also provides for a method of producing a planar lightwave circuit comprising: producing a trench in a substrate, the trench exhibiting a sloped wall presenting an oblique angle to a top surface of the substrate; and securing an optical element in contact with the sloped wall.

In one embodiment the oblique angle is in the range of 5°-85°, preferably 30°-70°.

The invention also provides for a method of producing a planar lightwave circuit comprising: producing a trench in a substrate, the trench exhibiting a sloped wall presenting an oblique angle to a top surface of the substrate; and securing an optical element in contact with the sloped wall; placing the substrate in a first position wherein the sloped wall presents a 90° angle to a bonder; securing a connection to a pad located on a surface of the optical element; and rotating the substrate having the optical element secured thereto to a second position wherein the substrate presents a 90° angle to the bonder; and securing a connection to a pad located on the substrate.

In one embodiment the rotating is accomplished pneumatically. In another embodiment the rotating is accomplished under control of the bonder. In yet another embodiment the rotating is accomplished electrically.

In one embodiment the bonder is one of a ball bonder and a wedge bonder. In an exemplary embodiment the oblique angle is in the range of 5°-85°, preferably 30°-70°.

Additional features and advantages of the invention will become apparent from the following drawings and description.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 illustrates a side view of a PLC based optical component comprising an optical element attached according to a first embodiment of the principle of the invention;

FIG. 2 illustrates a top view of the PLC based optical component of FIG. 1;

FIG. 3a illustrates the PLC based optical component of FIG. 1 in a tiltable jig for use with a bonder in a first position;

FIG. 3b illustrates the PLC based based optical component of FIG. 1 in a tiltable jig for use with a bonder in a second position;

FIG. 4 illustrates a side view of a PLC based optical component comprising an optical element attached according to a second embodiment of the principle of the invention; and

FIG. 5 illustrates a top view of the PLC based optical component of FIG. 4.

### DETAILED DESCRIPTION OF THE PREFERRED EMBODIMENTS

The present embodiments enable an improved means of attaching an optical element, such as a photodiode (PD) to a PLC based structure. This is provided in the present invention by forming a trench in the PLC, the trench exhibiting at least one sloped wall, and placing the element in the trench secured against the sloped wall with its active optical surface obliquely facing a fiber or waveguide facet. Preferably the active optical input exhibits an angle of between 5-85° to the center axis of the optical waveguide. Further preferably, the angle is between 30-70°. Preferably a bonder, such as a ball or wedge bonder, is used to connect to the metal pad on the top surface; the element being supported against the sloped wall of the trench.

The invention also provides for a tilting platform for a PLC. The platform supports the PLC substrate and provides two positions. In a first position the substrate is placed at an angle to the horizontal such that the optical element placed in the trench against the sloped wall presents a 90° angle to the bonder. In a second position the substrate is placed horizontally thereby presenting a 90 angle° to the bonder for connection to a pad on the top surface of the PLC.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

The invention is herein being described in relation to a photodiode (PD) however this is not meant to be limiting in any way. The invention is equally applicable to any optical component or element being attached to a PLC including, but not limited to, FPLD, VCSELs and VECSELs.

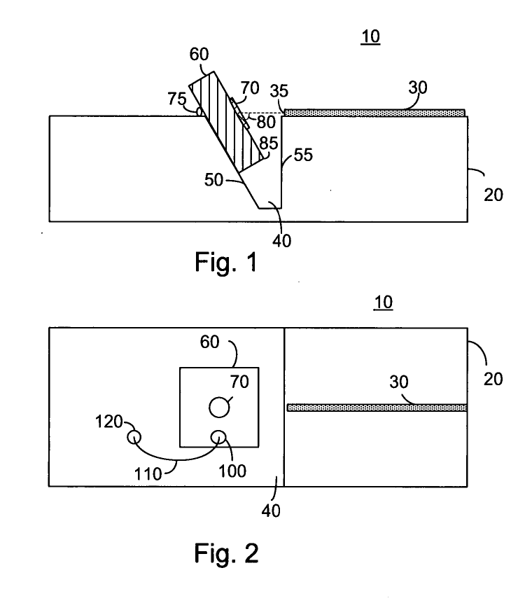

FIG. 1 illustrates a side view of a PLC based optical component 10 comprising an optical element attached according to a first embodiment of the principle of the invention. PLC based optical component 10 comprises: substrate 20; waveguide 30 exhibiting face 35; trench 40 exhibiting sloped wall 50 and wall 55; PD 60 having active surface 70 and exhibiting corner 85; and silver paste or solder ball 75. Angle 80 represents the angle between an imaginary line continuing from the center axis of waveguide 30 and the plane of active surface 70. It is to be understood that what is meant by the plane of active surface 70 is the plane of optimal placement against an incident light beam. Waveguide 30 is illustrated as being present on the top of substrate 20 however this is not meant to be limiting in any way, and waveguide 30 may be buried by other layers without exceeding the scope of the invention. In one embodiment waveguide 30 may be an optical fiber end.

Trench 40 is cut in front of face 35 of waveguide 30 to enable placement of PD 60. In an exemplary embodiment trench 40 is cut by a saw having a blade designed to create sloped wall 50 at the desired angle. Sloped wall 50 of trench 40 opposes face 35 and is set an angle to support PD 60 and present active surface 70 of PD 60 to light emerging from face 35 of waveguide 30. PD 60 is placed on sloped wall 50 and secured by an adhesive. In an exemplary embodiment PD 60 is placed so that corner 85 contacts wall 55, the size of trench 40 and the slope of sloped wall 50 thereby ensuring proper alignment of PD 60 and waveguide 30. In the event that a connection point appears on the back surface of PD 60, silver paste or solder ball 75 is used to both secure and make a connection. PD 60 is removed from face 35 of waveguide 30 as a function of angle 80 and the width of trench 40. Advantageously, a metal pad (not shown) located parallel to or above active surface 70 is directly approachable by a head of a ball or wedge bonder. In a preferred embodiment angle 80 is between 5-85°, even further preferably 30-70°. It is to be noted that proper placement of PD 60 in trench 40 of PLC based optical component 10 is primarily a function of the requirement to align the center of active surface 70 with light emanating from face 35 of waveguide 30

FIG. 2 illustrates a top view of the PLC based optical component 10 of FIG. 1 additionally illustrating metal pad 100 of PD 60, flying wire 110 and metal pad 120 of substrate 20. PD 60 is illustrated having active area 70 centrally located and metal pad 100 positioned on a horizontal plane approximately equal to the center of active area 70. Such a layout is advantageous in that proper alignment of active area 70 with the output of waveguide 30 further ensures proper mechanical support during attachment of a lead to metal pad 100. Flying wire 110 is connected as known to those skilled in the art to metal pad 120 on substrate 20.

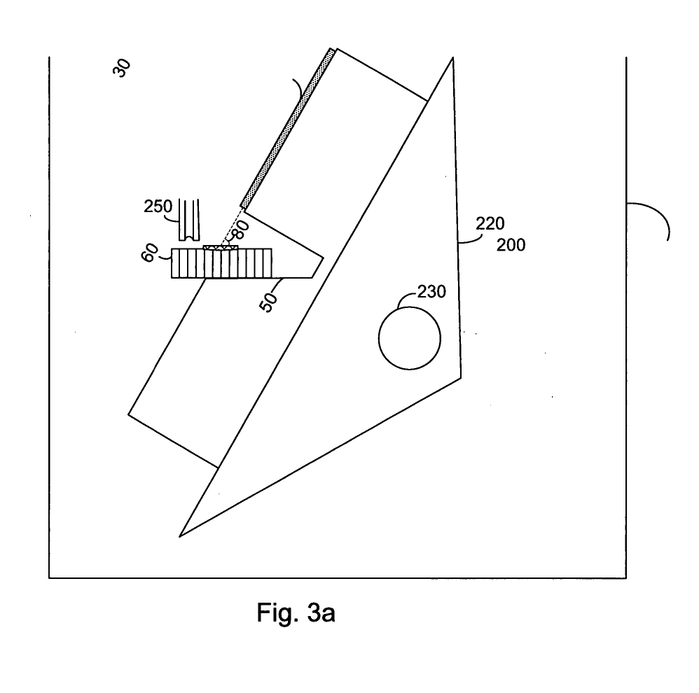

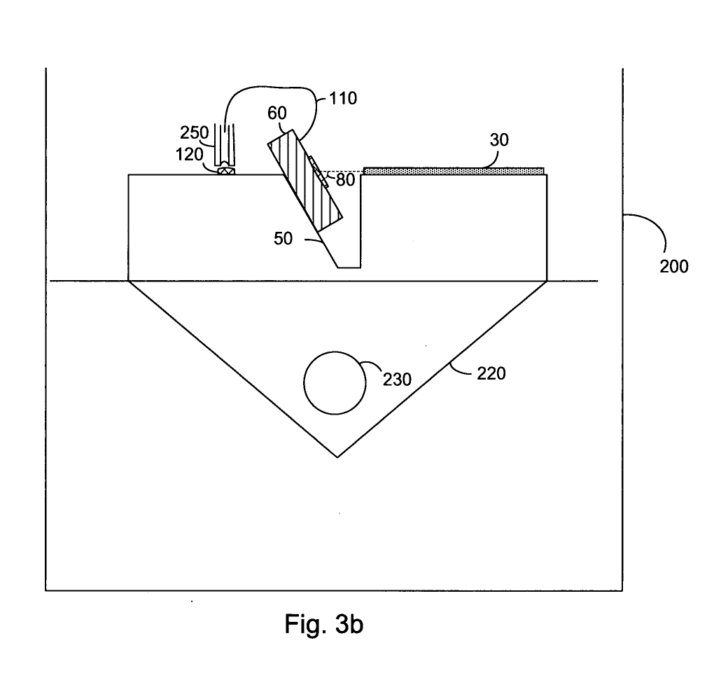

FIG. 3a illustrates PLC based optical component 10 placed on a tiltable jig 200, jig 200 being illustrated in a first position. Tiltable jig 200 comprises support 220 and pivot 230. Support 220 is provided with 2 positions while rotating on pivot 230 as will be described further hereinto below. Tiltable jig 200 is preferably provided with mechanical stops to ensure correct placement of support 220. In operation, support 220 is placed in the first position and a capillary head 250 of a ball or wedge bonder is placed in position adjacent to metal pad 100 of PD 60. It is to be noted that metal pad 100 of PD 60 is held horizontally, thus enabling connection by commercially available ball or wedge bonders. In particular, commercially available bonders typically require that the surface to be bonded be at a 90° angle to the bonder. In the case of a ball bonder this means a 90° angle to the capillary axis of the ball bonder and in the case of a wedge bonder a 90° angle to the longitudinal wedge axis of the wedge bonder.

FIG. 3b illustrates PLC based optical component 10 placed on tiltable jig 200, jig 200 being illustrated in a second position. Support 220 is rotated on pivot 230 to the second position and capillary head 250 of the ball or wedge bonder is placed in position adjacent to metal pad 120 of PD 60. It is to be noted that in the second position of tiltable jig 200 metal pad 120 is held horizontally, thus enabling connection by commercially available ball or wedge bonders. Support 220 may be tilted between the first and second position in any manner, preferably pneumatically or via an electric motor under control of the bonder thus enabling automatic connection.

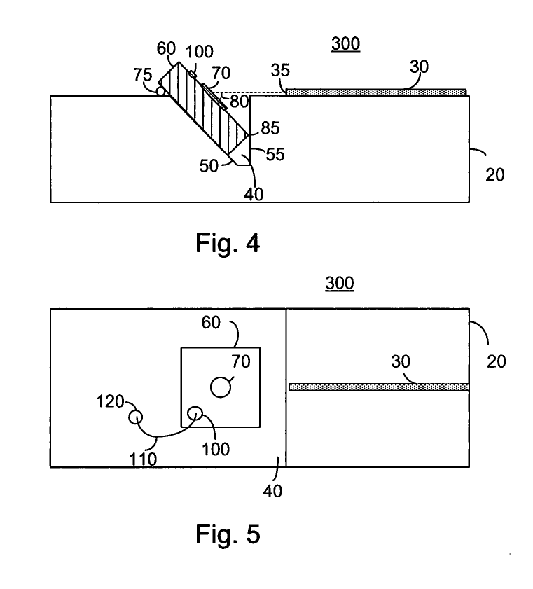

FIG. 4 illustrates a side view of a PLC based optical component 300 comprising an optical element attached according to a second embodiment of the principle of the invention. PLC based optical component 300 comprises: substrate 20; waveguide 30 exhibiting face 35; trench 40 exhibiting sloped wall 50 and wall 55; PD 60 having active surface 70 and exhibiting corner 85; and silver paste or solder ball 75. Angle 80 represents the angle between an imaginary line continuing from the center axis of waveguide 30 and the plane of active surface 70. It is to be understood that what is meant by the plane of active surface 70 is the plane of optimal placement against an incident light beam. Waveguide 30 is illustrated as being present on the top of substrate 20 however this is not meant to be limiting in any way, and waveguide 30 may be buried by other layers without exceeding the scope of the invention. In one embodiment waveguide 30 may be an optical fiber end.

Trench 40 is cut in front of face 35 of waveguide 30 to enable placement of PD 60. In an exemplary embodiment trench 40 is cut by a saw having a blade designed to create sloped wall 50 at the desired angle. Sloped wall 50 of trench 40 opposing face 35 is set an angle to support PD 60 and present active surface 70 of PD 60 to light emerging from face 35 of waveguide 30. PD 60 is placed on sloped wall 50 and secured by adhesive and/or silver paste or solder ball 310. PD 60 is further placed so that corner 85 contacts wall 55 of trench 40, the size of trench 40 and the slope of sloped wall 50 thereby ensuring proper alignment of PD 60 and waveguide 30. Silver paste or solder ball 75 acts to connect an electrical pad on the back of PD 60 to a metal pad on the surface of substrate 20. PD 60 is removed from face 35 of waveguide 30 as a function of angle 80 and the width of trench 40. Advantageously, a metal pad 100 located parallel to or above active surface 70 is directly approachable by a capillary head of a wedge or ball bonder. In a preferred embodiment angle 80 is between 5-85°, even further preferably 30-70°. In the embodiment of FIG. 4 support for metal pad 100 preferably extends horizontally above the center of active surface 70.

FIG. 5 illustrates a top view of the PLC based optical component 300 of FIG. 4 additionally illustrating metal pad 100 of PD 60, flying wire 110 and metal pad 120 of substrate 20. PD 60 is illustrated having active area 70 centrally located and metal pad 100 enabling connection located out of the horizontal plane of the center of active area 70. Flying wire 110 is connected as known to those skilled in the art to metal pad 120 on a surface of substrate 20. It is to be noted that proper placement of PD 60 in trench 40 of PLC based optical component 300 is primarily a function of the requirement to align the center of active surface 70 with light emanating from face 35 of waveguide 30.

The invention has been illustrated with two types of PD 60 both exhibiting a single connection point, or metal pad, on the front surface, however this is not meant to be limiting in any way. PD 60 may be provided with a plurality of connection points on the front surface, thus connection to the back surface may not be required. The plurality of connection points are each supported in accordance with the invention.

The invention has been illustrated with a photodiode, however this is not meant to be limiting in any way. Other element, and particularly other optical elements may be used in accordance with the teaching of the invention without exceeding its scope.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof, which would occur to persons skilled in the art upon reading the foregoing description.

1. A planar lightwave circuit comprising:
a substrate;
an optical waveguide;
a trench cut in said substrate opposing a face of said optical waveguide, said trench comprising a sloped wall exhibiting an oblique angle with a center axis of said optical waveguide, said sloped wall opposing said face of said optical waveguide; and
an optical element having an active optical area exhibiting a plane, said optical element being secured on said sloped wall such that said plane of said active optical area faces said optical waveguide at said oblique angle.

2. A planar lightwave circuit according to claim 1, wherein said optical element comprises at least one metal pad facing said optical waveguide, said optical element being supported by said substrate on a face of said optical element directly opposing said metal pad.

3. A planar lightwave circuit according to claim 1, wherein said optical element comprises at least one metal pad facing said sloped wall, said metal pad being connected by silver paste.

4. A planar lightwave circuit according to claim 1, wherein said optical element comprises one of a photodiode, Fabry Perot laser diode, vertical cavity surface emitting laser and a vertical external cavity surface emitting laser.

5. A planar lightwave circuit according to claim 1, wherein said oblique angle is in the range of 5°-85°.

6. A planar lightwave circuit according to claim 1, wherein said oblique angle is in the range of 30°-70°.

7. A planar lightwave circuit according to claim 1, wherein said optical waveguide is an optical fiber end.

8. A planar lightwave circuit according to claim 1, wherein said trench further comprises a wall generally opposing said sloped wall, a corner of said optical element being in contact with said wall generally opposing said sloped wall, whereby said optical element is aligned at least partially by said being in contact.

9. A method of producing a planar lightwave circuit comprising:
producing a trench in a substrate, said trench exhibiting a sloped wall presenting an oblique angle to a top surface of said substrate; and
securing an optical element in contact with said sloped wall.

10. A method according to claim 9, wherein said oblique angle is in the range of 5°-85°.

11. A method according to claim 9, wherein said oblique angle is in the range of 30°-70°.

12. A method of producing a planar lightwave circuit comprising:
producing a trench in a substrate, said trench exhibiting a sloped wall presenting an oblique angle to a top surface of said substrate; and
securing an optical element in contact with said sloped wall;
placing said substrate in a first position wherein said sloped wall presents a 90° angle to a bonder;
securing a connection to a pad located on a surface of said optical element; and
rotating said substrate having said optical element secured thereto to a second position wherein said substrate presents a 90° angle to said bonder; and
securing a connection to a pad located on said substrate.

13. A method according to claim 12, wherein said rotating is accomplished pneumatically.

14. A method according to claim 12, wherein said rotating is accomplished under control of said bonder.

15. A method according to claim 12, wherein said rotating is accomplished electrically.

16. A method according to claim 12, wherein said bonder is one of a ball bonder and a wedge bonder.

17. A method according to claim 12, wherein said oblique angle is in the range of 5°-85°.

18. A method according to claim 12, wherein said oblique angle is in the range of 30°-70°.
